(19) United States
(12) Patent Application Publication
(10) Pub. No.: US 2017/0135030 A1
(43) Pub. Date: May 11, 2017

(54) METHOD AND APPARATUS FOR SWITCHING AMONG CLIENT IDENTIFICATION MODULES

(71) Applicant: LEAUTO INTELLIGENT TECHNOLOGY (BEIJING) CO. LTD, Chaoyang District Beijing (CN)

(72) Inventors: Lingfei Xie, Chaoyang District Beijing (CN); Mujin Wang, Chaoyang District Beijing (CN)

(21) Appl. No.: 14/978,667

(22) Filed: Dec. 22, 2015

(30) Foreign Application Priority Data
Nov. 10, 2015 (CN) 2015107633207

(51) Int. Cl. H04W 48/18; H04W 72/04; H04L 12/26

(52) U.S. Cl. CPC H04W 48/18; H04L 43/0894; H04W 72/0486

(57) ABSTRACT

The present disclosure discloses a method and an apparatus for switching among client identification modules, the method and the apparatus being suitable for use in portable routers including multiple client identification modules, wherein the method includes: acquiring parameter information corresponding to the multiple client identification modules; acquiring use state information of the multiple client identification modules one after another according to the parameter information corresponding to the multiple client identification modules; selecting from the multiple client identification modules a client identification module for providing network connection service according to the use state information of the multiple client identification modules. This proposal achieves intelligent switching among and reasonable use of multiple client identification modules.

### CROSS-REFERENCE TO RELATED APPLICATIONS

This application is based upon and claims priority to Chinese Patent Application 201510763320.7, titled “Method and Apparatus for Switching among Client Identification Modules”, filed on Nov. 10, 2015, the entire contents of which are incorporated herein by reference.

### FIELD OF TECHNOLOGY

The present disclosure generally relates to a technical field of Internet, and more particularly, to a method and an apparatus for switching among client identification modules.

### BACKGROUND

In line with the incessant popularization of the Internet, people become accustomed to acquiring information, service, etc., via the Internet. For the sake of more convenient use of the Internet, people have developed and manufactured portable routers. Such portable routers emit WIFI signals after being inserted with a client identification module, i.e., an SIM card, enabling mobile phones, tablet PC, or laptop PC, etc. to access the Internet via the WIFI.

At this point, however, most portable routers support a sole carrier only, for example, some portable routers only support China Mobile SIM cards, and some portable routers only support China Unicom SIM cards. Due to such restrictions as the carrier's base station layout and others, the signal coverage and signal connection in a same region differ from carrier to carrier, for example, in a same region China Mobile signal might be good but China Unicom signal might be poor and, in this case and if the user's portable router only support China Unicom SIM cards, the network speed will be adversely influenced, downgrading the user's use experience.

### SUMMARY

Given the above-related problems, the present disclosure is proposed with the objective of providing a method of communication and an apparatus of communication between devices that are capable of solving, or at least partially solving, the above-related problems.

According to one aspect of the present disclosure, there is provided a method for switching among client identification modules, the method being suitable for use in portable routers that include multiple client identification modules, and the method including:

acquiring parameter information corresponding to the multiple client identification modules;

acquiring use state information of the multiple client identification modules one after another according to the parameter information corresponding to the multiple client identification modules; and

selecting from the multiple client identification modules a client identification module for providing network connection service according to the use state information of the multiple client identification modules.

Further, the parameter information includes: carrier information, used traffic information, and signal state information.

Further, acquiring use state information of the multiple client identification modules one after another according to the parameter information corresponding to the multiple client identification modules further includes:

for each client identification module, judging whether there is any preset traffic ceiling; if yes, then checking the used traffic information corresponding to the client identification module; if no, then checking the signal state information corresponding to the client identification module.

Further, checking the used traffic information corresponding to the client identification module further includes: according to the used traffic information corresponding to the client identification module, judging whether the used traffic has exceeded the preset traffic ceiling; if yes, then stopping using the client identification module to provide network connection service; if not, then checking the signal state information corresponding to the client identification module.

Further, checking the used traffic information corresponding to the client identification module further includes: according to the used traffic information corresponding to the client identification module, judging whether the used traffic has exceeded the preset traffic ceiling;

if yes, then judging whether there is any setting that stops using the client identification module to provide network connection service;

if not, then checking the signal state information corresponding to the client identification module;

wherein judging whether there is any setting that stops using the client identification module to provide network connection service; if yes, then stopping using the client identification module to provide network connection service; if no, then checking the signal state information corresponding to the client identification module.

Further, selecting from the multiple client identification modules a client identification module for providing network connection service according to the use state information of the multiple client identification modules further includes: according to the signal state information which is acquired after checking, corresponding to the client identification modules, selecting from the multiple client identification modules a client identification module for providing network connection service.

According to another aspect of the present disclosure, there is provided an apparatus for switching among client identification modules, and the apparatus including:

one or more processors; and

a memory;

one or more programs, wherein one or more programs are stored in the memory, and when executed by the one or more processors, the one or more programs cause the one or more processors to perform:

acquiring parameter information corresponding to the multiple client identification modules;

acquiring use state information of the multiple client identification modules one after another according to the parameter information corresponding to the multiple client identification modules; and

selecting from the multiple client identification modules a client identification module for providing network connection service according to the use state information of the multiple client identification modules.

Further, the parameter information includes: carrier information, used traffic information, and signal state information.

Further, the one or more processors are further configured to perform:

for each client identification module, judging whether there is any preset traffic ceiling; if yes, then checking the used traffic information corresponding to the client identification module; if no, then checking the signal state information corresponding to the client identification module.

Further, the one or more processors are further configured to perform:

according to the used traffic information corresponding to the client identification module, judging whether the used traffic has exceeded the preset traffic ceiling; if yes, then stopping using the client identification module to provide network connection service; if not then checking the signal state information corresponding to the client identification module.

Further, the one or more processors are further configured to perform:

according to the used traffic information corresponding to the client identification module, judging whether the used traffic has exceeded the preset traffic ceiling;

if yes, then judging whether there is any setting that stops using the client identification module to provide network connection service;

if not, then checking the signal state information corresponding to the client identification module;

wherein judging whether there is any setting that stops using the client identification module to provide network connection service; if yes, then stopping using the client identification module to provide network connection service; if no, then checking the signal state information corresponding to the client identification module.

Further, the one or more processors are further configured to perform:

according to the signal state information which is acquired after checking, corresponding to the client identification modules, selecting from the multiple client identification modules a client identification module for providing network connection service.

The technical proposal according to the present disclosure, suitable for use in portable routers including multiple client identification modules, acquiring the parameter information corresponding to the multiple client identification modules, then acquiring the use state information of the multiple client identification modules one after another according to the parameter information corresponding to the multiple client identification modules, and finally selecting from the multiple client identification modules a client identification module for providing network connection service according to the use state information of the multiple client identification modules. The technical proposal provided by the present disclosure selects from the multiple client identification modules a client identification module most suitable for providing network connection service after giving balanced consideration to the use state information of the multiple client identification modules, thus achieving intelligent switching among and reasonable use of multiple client identification modules.

The above illustration is only a general description of the technical solutions provided by the present disclosure, aiming at making the technical means of the present disclosure understood more clearly and thereby practiced based on the contents of the specification. Further, in order to make the above and other objects, features and advantages of the present disclosure more obvious, specific implementations of the present disclosure will be exemplified below.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements. Of the drawings:

FIG. 1 is a schematic process flow chart for the method of switching among client identification modules according to an embodiment of the disclosure;

FIG. 2 is a schematic process flow chart for the method of switching among client identification modules according to another embodiment of the disclosure;

FIG. 3 is a schematic function structure diagram for the apparatus of switching among client identification modules according to an embodiment of the disclosure;

FIG. 4 is a structural block diagram for the apparatus of switching among client identification modules according to another embodiment of the present disclosure.

### DESCRIPTION OF THE EMBODIMENTS

Exemplary embodiments of the present disclosure will be described below in detail with reference to drawings. Even though exemplary embodiments of the present disclosure are presented in drawings, it shall be appreciated that the present disclosure may be practiced in various manners without being limited to the embodiments set forth herein. Instead, the embodiments are provided herein to make the present disclosure be understood more thoroughly and to more completely convey the scope of the present disclosure to one of ordinary skill in this art.

To get freed from the restriction of the carrier's base station layout, a portable router may include client identification modules of multiple carriers. When the portable router includes multiple client identification modules, the user may select manually a client identification module by use of the mobile phone client terminal or relevant application on the computer or may configure for intelligent switching among client identification modules. Wherein, the client identification modules can be, for example, SIM cards, and in particular, the client identification modules can be network cards or data cards, etc., wherein the network cards provide network accessing service, the data cards not only provide network accessing service but also provide voice call service, etc. With prior art, major carriers are China Mobile, China Unicom, and China Telecom; therefore, the client identification modules can be China Mobile SIM cards, China Unicom SIM cards, or China Telecom SIM cards.

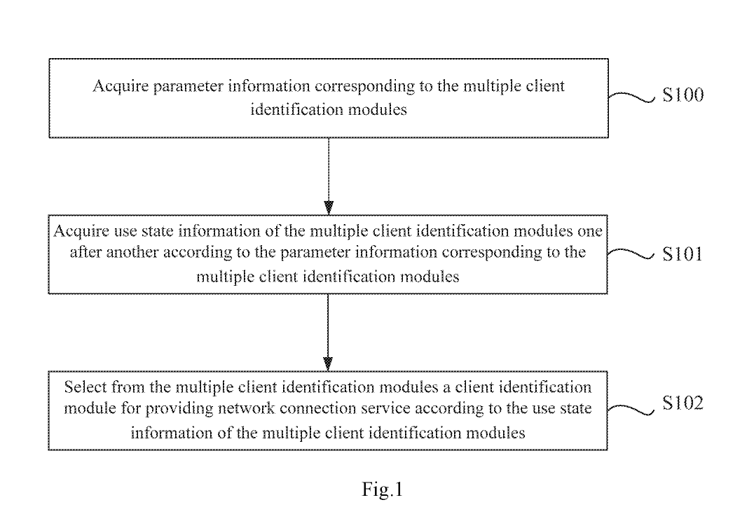

FIG. 1 is a schematic process flow chart for the method of switching among client identification modules according to an embodiment of the present disclosure, the method being suitable for use in portable routers including multiple client identification modules, and as shown in FIG. 1, the method including the following steps:

Step S100: acquiring parameter information corresponding to the multiple client identification modules.

To achieve automatic switching among and reasonable use of multiple client identification modules, Step S100 needs to acquire parameter information corresponding to the multiple client identification modules. Wherein, the parameter information includes: carrier information, used traffic information, and signal state information. For example, with prior art, major carriers are China Mobile, China Unicom, and China Telecom and, therefore, the carrier information can be China Mobile, China Unicom, or China Telecom. From the used traffic information of a client identification module, one may know the information on used traffic of the client identification module. Signal state information includes signal strength, PING value, and error package information. Wherein, a PING value is the time elapses from the time when a computer or mobile phone, etc. sends data to a network server to the time when the computer or mobile phone, etc. receives the feedback data from the network server, and generally PING values are expressed in milliseconds. From the signal state information of a client identification module, one may know the information on the signal state of the client identification module.

Step S101: acquiring use state information of the multiple client identification modules one after another according to the parameter information corresponding to the multiple client identification modules.

After the acquiring of, in Step S100, the parameter information corresponding to the multiple client identification modules, Step S101 acquires the use state information of the multiple client identification modules according to the used traffic information and the signal state information corresponding to the multiple client identification modules.

Step S102: selecting from the multiple client identification modules a client identification module for providing network connection service according to the use state information of the multiple client identification modules.

After the acquiring of, in Step S101, the use state information of the multiple client identification modules, Step S102 selects from the multiple client identification modules a client identification module most suitable for providing network connection service according to the use state information of the multiple client identification modules, hence achieving intelligent switching among and reasonable use of the multiple client identification modules.

The method of switching among client identification modules provided according to the embodiment, suitable for use in portable routers including multiple client identification modules, acquiring the parameter information corresponding to the multiple client identification modules, then acquiring the use state information of the multiple client identification modules one after another according to the parameter information corresponding to the multiple client identification modules, and finally selecting from the multiple client identification modules a client identification module for providing network connection service according to the use state information of the multiple client identification modules. The technical proposal provided by the present disclosure selects from the multiple client identification modules a client identification module most suitable for providing network connection service after giving balanced consideration to the use state information of the multiple client identification modules, thus achieving intelligent switching among and reasonable use of multiple client identification modules.

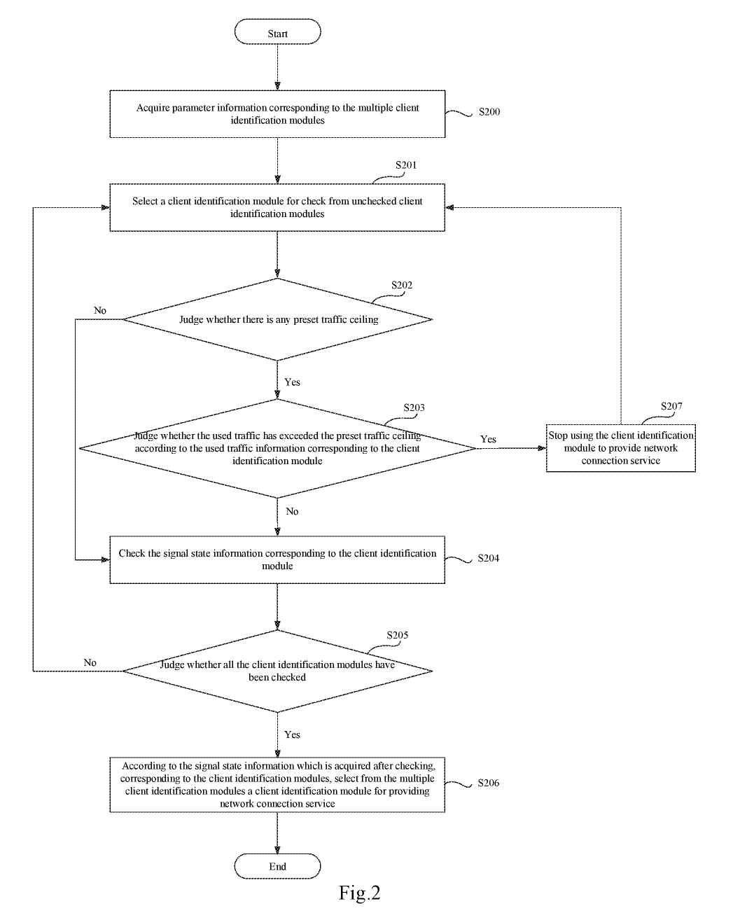

FIG. 2 is a schematic process flow chart for the method of switching among client identification modules according to another embodiment of the present disclosure, the method being suitable for use in portable routers including multiple client identification modules, and as shown in FIG. 2, the method, once started, including the following steps:

Step S200: acquiring parameter information corresponding to the multiple client identification modules.

Wherein, the parameter information includes: carrier information, used traffic information, and signal state information. For example, the carrier information may include China Mobile, China Unicom, and China Telecom. Used traffic information includes information on used traffic. Signal state information includes signal strength, PING value, and error package information.

For example, a portable router includes three client identification modules, the three client identification modules being the first client identification module, the second client identification module, and the third client identification module respectively. Assuming the carrier information corresponding to the three client identification modules is acquired in Step S200 and, according to such carrier information it is known that the first client identification module is China Mobile, the second client identification module is China Unicom, and the third client identification module is China Telecom. If, in the environment in which the portable router exists, China Mobile signal is good and China Telecom signal is poor, then it can be known from the signal state information that the first client identification module is good in signal and the third client identification module is poor in signal.

Step S201: selecting a client identification module for check from unchecked client identification modules.

Step S202: judging whether there is any preset traffic ceiling; if yes, then proceeding to Step S203; if no, then proceeding to Step S204.

For example, a portable router includes three client identification modules, the three client identification modules being the first client identification module, the second client identification module, and the third client identification module respectively. Assuming the first client identification module is selected for check and is judged whether to having contained any preset traffic ceiling; if there is a preset traffic ceiling, then Step S203 is executed; if there is no preset traffic ceiling, then Step S204 is executed.

Step S203: judging whether the used traffic has exceeded the preset traffic ceiling according to the used traffic information corresponding to the client identification module; if yes, then proceeding to Step S207; if not, then proceeding to Step S204.

Assuming the user set a traffic ceiling of 200M with respect to the first client identification module and it is known from the used traffic information corresponding to the first client identification module that 150M has been used, it is then judged that the used traffic has not exceeded the preset traffic ceiling and Step S204 is then executed.

Step S204: checking the signal state information corresponding to the client identification module.

If it is judged, in Step S203, that the used traffic has not exceeded the preset ceiling, then the first client identification module is checked for its signal state information and it is then found that the current signal of the first client identification module is good.

Step S205: judging whether all the client identification modules have been checked; if yes, then proceeding to Step S206; if not, then proceeding to Step S201.

After judging and checking the first client identification module, it is needed to judge and check the second client identification module and the third client identification module. For example, if with respect to the second client identification module it is judged in Step S202 there is a preset traffic ceiling and Step S203 is then executed and it is judged that, according to the used traffic information corresponding to the second client identification module, the used traffic has exceeded the preset traffic ceiling, then Step S207 is executed and the second client identification module is not used for providing network connection service straightaway without checking the signal state information of the second client identification module in order to save traffic cost. With respect to the third client identification module, after it has been judged in Step S202 that there is no preset traffic ceiling, Step S204 is executed to check the signal state information corresponding to the third client identification module.

Step S206: according to the signal state information which is acquired after checking, corresponding to the client identification modules, selecting from the multiple client identification modules a client identification module for providing network connection service.

If, it is known according to the signal state information, which is acquired after checking, corresponding to the client identification modules that in current environment the first client identification module is good in signal, the third client identification module is poor in signal, and the used traffic of the second client identification module has exceeded the traffic ceiling, so the second client identification module is not used for providing network connection service in order to save traffic cost, and from the first and the third client identification modules a client identification module with good signal, in this case the first client identification module, is selected for providing network connection service; in this way, intelligent switching among multiple client identification modules and reasonable traffic allocation among multiple client identification modules are achieved, traffic cost is save, and the user is provided as well with a faster Internet surfing environment, therefore improving the user's experience.

Step S207: stopping using the client identification module to provide network connection service.

If it is judged in Step S203 that the used traffic of a client identification module exceeds the preset traffic ceiling, the client identification module is then disused for providing network connection service in order to avoid incurring traffic cost overrun. After the completion of Step S207, Step S201 is executed to select from unchecked client identification modules a client identification module for check.

Optionally, this method may further include, after judging in Step S203 that the used traffic of a client identification module exceeds the preset traffic ceiling, judging whether there is any setting that stops using the client identification module to provide network connection service, that is if it is judged in Step S203 that the used traffic has exceeded the traffic ceiling, then it is further judged whether there is any setting that stops using the client identification module to provide network connection service. Particularly, it is judged whether there is any setting that stops using the client identification module to provide network connection service; if yes, then the step of stopping using the client identification module to provide network connection service is executed; if no, then Step S204 is implemented to check the signal state information corresponding to the client identification module.

The method of switching among client identification modules provided according to the embodiment, suitable for use in portable routers including multiple client identification modules, acquiring the parameter information corresponding to the multiple client identification modules, and then selecting, according to the preset traffic ceiling information, used traffic information, and signal state information corresponding to the multiple client identification modules, from the multiple client identification modules a client identification module for providing network connection service. The technical proposal provided by the present disclosure not only achieves intelligent switching among multiple client identification modules and reasonable traffic allocation among multiple client identification modules, saves traffic cost, but also provides the user with a faster Internet surfing environment, therefore improving the user's experience.

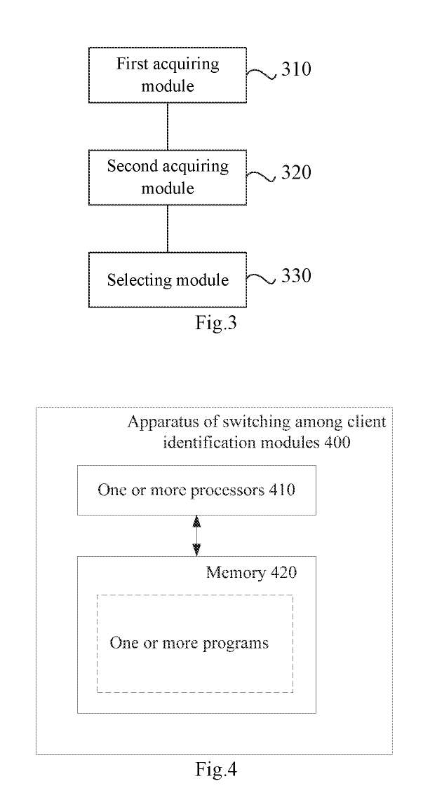

FIG. 3 is a schematic function structure diagram for the apparatus of switching among client identification modules according to an embodiment of the present disclosure, the apparatus being suitable for use in portable routers including multiple client identification modules, and as shown in FIG. 3, the apparatus including: a first acquiring module 310, a second acquiring module 320, and a selecting module 330.

The first acquiring module 310, configured to acquire parameter information corresponding to the multiple client identification modules.

When a portable router includes multiple client identification modules, the first acquiring module 310 needs to acquire parameter information corresponding to the multiple client identification modules so as to achieve automatic switching among and reasonable use of multiple client identification modules. Wherein, the parameter information includes: carrier information, used traffic information, and signal state information. Signal state information includes signal strength, PING value, and error package information.

The second acquiring module 320, configured to acquire the use state information of the multiple client identification modules one after another according to the parameter information corresponding to the multiple client identification modules.

The second acquiring module 320 is further configured to: judge whether there is any preset traffic ceiling for each client identification module; if yes, then check the used traffic information corresponding to the client identification module; if no, then check the signal state information corresponding to the client identification module.

The second acquiring module 320 is further configured to: judge whether the used traffic has exceeded the preset traffic ceiling according to the used traffic information corresponding to the client identification module; if yes, then stop using the client identification module to provide network connection service; if not, then check the signal state information corresponding to the client identification module.

The selecting module 330, configured to select from the multiple client identification modules a client identification module for providing network connection service according to the use state information of the multiple client identification modules.

The selecting module 330 is further configured to: select from the multiple client identification modules a client identification module for providing network connection service according to the signal state information which is acquired after checking, corresponding to the client identification modules.

For example, a portable router includes three client identification modules, the three client identification modules being the first client identification module, the second client identification module, and the third client identification module respectively. Assuming the judging and checking by the second acquiring module 320 find that: with respect to the first client identification module the user has set a traffic ceiling, the used traffic has not yet exceeded the preset traffic ceiling, and the first client identification module is good in signal; with respect to the second client identification module, the user has set a traffic ceiling and the used traffic has exceeded the preset traffic ceiling; with respect to the third client identification module, the user has not set any traffic ceiling and the signal is poor. Thus, the selecting module 330 selects from the first client identification module and the third client identification module which are able to provide network connection service, a client identification module with good signal, in this case the first client identification module, as the client identification module for providing network connection service, in this way, intelligent switching among multiple client identification modules and reasonable traffic allocation among multiple client identification modules are achieved, the traffic cost is save, and the user is provided as well with a faster Internet surfing environment, therefore improving the user's experience.

Optionally, the second acquiring module 320 is further configured to: judge whether the used traffic has exceeded the preset traffic ceiling according to the used traffic information corresponding to the client identification module; if yes, judge whether there is any setting that sops using the client identification module to provide network connection service; if not, then check the signal state corresponding to the client identification module.

Wherein, it is judged whether there is any setting that stops using the client identification module to provide network connection service; if yes, then stopping using the client identification module to provide network connection service; if no, then checking the signal state corresponding to the client identification module.

The apparatus of switching among client identification modules provided according to the embodiment, suitable for use in portable routers including multiple client identification modules, the parameter information corresponding to the multiple client identification modules being acquired by use of a first acquiring module, then the use state information of the multiple client identification modules one after another according to the preset traffic ceiling information, used traffic information, and signal state information corresponding to the multiple client identification modules being acquired by use of a second acquiring module, and finally according to the use state information of the multiple client identification modules, a client identification module for providing network connection service being selected from the multiple client identification modules by use of a selecting module. The technical proposal provided by the present disclosure not only achieves intelligent switching among multiple client identification modules and reasonable traffic allocation among multiple client identification modules, saves traffic cost, but also provides the user with a faster Internet surfing environment, therefore improving the user's experience.

FIG. 4 is a structural block diagram for the apparatus of switching among client identification modules according to another embodiment of the present disclosure. The apparatus of switching among client identification modules 400 includes: one or more processors 410; and a memory 420; one or more programs, wherein one or more programs are stored in the memory, and when executed by the one or more processors, the one or more programs cause the one or more processors to perform the method provided in the present disclosure.

The algorithms and illustrations given herein are not intrinsically related to any specific computer, virtual system, or other device. Various generic systems may also work with what are instructed and illustrated herein. According to the above description, the structure and components to build such systems are obvious. Moreover, the present disclosure is not limited to any specific programming language. It is understandable that the content of the present disclosure described herein may be realized in various programming languages and the description given above for any particular language is for the purpose of disclosing the optimum embodiment of the present disclosure.

The description given herein illustrates a lot of specific details. However, it is understandable that the embodiments of the present disclosure can be implemented under conditions without such specific details. In some examples, generally known methods, structures, or technologies have not been given specifically in order to avoid blurring the understanding of the description.

Similarly, it shall be understood that in the description of the exemplary embodiments of the present disclosure various characteristics of the present disclosure are sometimes grouped into an individual embodiment, diagram, figure, or description thereof for the sake of simplifying this disclosure and assisting in understanding one or more aspects of the present disclosure. However, the disclosed method should not be interpreted as reflecting the following intent: the present disclosure requested for protection demands more characteristics than the characteristics stated in each individual claim. To be more specific, as reflected in the following claims, the present disclosure aspects are fewer than all the characteristics disclosed above in individual embodiment. Hence, the claim pursuant to a specific embodiment is hereby expressly incorporated into the specific embodiment, wherein each claim per se is treated as an individual embodiment of the present disclosure.

Persons skilled in the art understand and can effect adaptive modification to the modules in the devices described in the embodiments and have them configured in one or more pieces of device other than that described in the embodiments. The modules or units or assemblies in the embodiments can be grouped into one module or unit or assembly, and, more than that, can be divided into multiple submodules or subunits or sub-assemblies. With the exception of at least those that are mutually repulsive among these characteristics and/or processes or units, all the characteristics disclosed in the description (including accompanying claims, abstract, and attached drawings) as well as any methods, or any process or unit of the device disclosed in such a way may be combined in any manner. Unless otherwise expressly stated, every characteristic disclosed in the description (including accompanying claims, abstract, and attached drawings) may be substituted by substitution characteristic that provides identical, equivalent, or similar purpose.

Moreover, persons of skill in the art can understand that although some embodiments illustrated herein include certain characteristics instead of other characteristics contained in other embodiments, the combination of characteristics from different embodiments are still within the scope of the present disclosure and thus form different embodiments. For example, in the following claims any of the embodiments for which protection is requested may be used in any combination.

The embodiments of each component of the present disclosure can be realized using hardware or using software modules running on one or more processors, or be realized by using them in combination. Persons skilled in the art should understand that some or all functions of some or all components according to the embodiments of the present disclosure can be realized in practice using microprocessors or digital signal processors (DSP). The present disclosure can also be realized as device or apparatus programs (e.g., computer program or computer program products) used to execute some or all of the methods described herein. Such realized programs of the present disclosure can be stored on computer readable media or can be in one or more signal forms. Such signals can become available by downloading from the Internet websites or be made available in media signals or in any other form.

It should be noted that the above embodiments provide description of the present disclosure rather than define the limits of the present disclosure, and persons of skill in the art may devise replacement embodiments without departing from the scope of the accompanying claims. In the claims, any reference symbol in brackets shall not constitute any limit to the claims. The word “include” does not rule out any elements or steps not listed in the claims. The word “a”, “an”, or “one” before an element do not rule out the existence of a plurality of such elements. The present disclosure can be realized by means of hardware consisting of several different elements or by means of appropriately programmed computers. In the unit claims where a number of apparatuses are listed, some of such apparatuses can be implemented in practice using a same hardware item. The word “first”, “firstly”, “second”, “secondly”, and “third” or “thirdly”, etc., do not connote any sequence or order. Such words may be interpreted as names.

1. A method for switching among client identification modules, wherein said method is suitable for use in portable routers comprising multiple client identification modules and said method comprises:
acquiring parameter information corresponding to said multiple client identification modules;
acquiring use state information of said multiple client identification modules one after another according to the parameter information corresponding to said multiple client identification modules; and
selecting from said multiple client identification modules a client identification module for providing network connection service according to the use state information of said multiple client identification modules.

2. The method according to claim 1, wherein said parameter information comprises: carrier information, used traffic information, and signal state information.

3. The method according to claim 2, wherein said acquiring use state information of said multiple client identification modules one after another according to the parameter information corresponding to said multiple client identification modules further comprises:
for each client identification module, judging whether there is any preset traffic ceiling; if yes, then checking the used traffic information corresponding to said client identification module; if no, then checking the signal state information corresponding to said client identification module.

4. The method according to claim 3, wherein said checking the used traffic information corresponding to said client identification module further comprises: according to the used traffic information corresponding to said client identification module, judging whether the used traffic has exceeded the preset traffic ceiling; if yes, then stopping using said client identification module to provide network connection service; if not then checking the signal state information corresponding to said client identification module.

5. The method according to claim 3, wherein said checking the used traffic information corresponding to said client identification module further comprises: according to the used traffic information corresponding to said client identification module, judging whether the used traffic has exceeded the preset traffic ceiling;
if yes, then judging whether there is any setting that stops using said client identification module to provide network connection service;
if not, then checking the signal state information corresponding to said client identification module;
wherein judging whether there is any setting that stops using said client identification module to provide network connection service; if yes, then stopping using said client identification module to provide network connection service; if no, then checking the signal state information corresponding to said client identification module.

6. The method according to claim 4, wherein said selecting, from said multiple client identification modules a client identification module for providing network connection service according to the use state information of said multiple client identification modules further comprises: according to the signal state information which is acquired after checking, corresponding to said client identification modules, selecting from said multiple client identification modules a client identification module for providing network connection service.

7. The method according to claim 5, wherein said selecting, from said multiple client identification modules a client identification module for providing network connection service according to the use state information of said multiple client identification modules further comprises: according to the signal state information which is acquired after checking, corresponding to said client identification modules, selecting from said multiple client identification modules a client identification module for providing network connection service.

8. An apparatus for switching among client identification modules, comprising:
one or more processors; and
a memory;
one or more programs, wherein one or more programs are stored in the memory, and when executed by the one or more processors, the one or more programs cause the one or more processors to perform:
acquiring parameter information corresponding to said multiple client identification modules;
acquiring use state information of said multiple client identification modules one after another according to the parameter information corresponding to said multiple client identification modules; and
selecting from said multiple client identification modules a client identification module for providing network connection service according to the use state information of said multiple client identification modules.

9. The apparatus according to claim 8, wherein said parameter information comprises: carrier information, used traffic information, and signal state information.

10. The apparatus according to claim 9, wherein the one or more processors are further configured to perform:
for each client identification module, judging whether there is any preset traffic ceiling; if yes, then checking the used traffic information corresponding to said client identification module; if no, then checking the signal state information corresponding to said client identification module.

11. The apparatus according to claim 10, wherein the one or more processors are further configured to perform:
according to the used traffic information corresponding to said client identification module, judging whether the used traffic has exceeded the preset traffic ceiling; if yes, then stopping using said client identification module to provide network connection service; if not then checking the signal state information corresponding to said client identification module.

12. The apparatus according to claim 10, wherein the one or more processors are further configured to perform:
according to the used traffic information corresponding to said client identification module, judging whether the used traffic has exceeded the preset traffic ceiling;
if yes, then judging whether there is any setting that stops using said client identification module to provide network connection service;
if not, then checking the signal state information corresponding to said client identification module;
wherein judging whether there is any setting that stops using said client identification module to provide network connection service; if yes, then stopping using said client identification module to provide network connection service; if no, then checking the signal state information corresponding to said client identification module.

13. The apparatus according to claim 11, wherein the one or more processors are further configured to perform:
according to the signal state information which is acquired after checking, corresponding to said client identification modules, selecting from said multiple client identification modules a client identification module for providing network connection service.

14. The apparatus according to claim 12, wherein the one or more processors are further configured to perform:
according to the signal state information which is acquired after checking, corresponding to said client identification modules, selecting from said multiple client identification modules a client identification module for providing network connection service.
